(19) United States
(12) Patent Application Publication
(10) Pub. No.: US 2026/0317215 A1
(43) Pub. Date: Oct. 15, 2026

(54) MODULAR, NON-METALLIC TANKS AND SYSTEM FOR REMOVING IMPURITIES FROM WASTE WATER

(71) Applicant: CLEAN WATER DEVELOPMENT LLC, Olmsted Township, OH (US)

(72) Inventors: Dwayne DILLINGHAM, Cleveland, OH (US); Patrick KENNEDY, Olmstead Township, OH (US); Austin DILLINGHAM, North Royalton, OH (US)

(21) Appl. No.: 19/485,483

(22) PCT Filed: May 20, 2024
(86) PCT No.: PCT/US2024/030195

§ 371 Date: Nov. 18, 2025

Related U.S. Application Data
(60) Provisional application No. 63/467,626, filed on May 19, 2023.

(51) Int. Cl. C02F 3/06; C02F 1/00; C02F 1/42; C02F 1/44; C02F 3/00; C02F 101/36

(52) U.S. Cl. CPC C02F 3/06; C02F 1/008; C02F 1/42; C02F 1/444; C02F 3/006; C02F 2101/36; C02F 2201/007; C02F 2203/006; C02F 2209/02; C02F 2209/44; C02F 2301/08

(57) ABSTRACT

A waste water treatment system is made from modular tanks connected in series. Each tank has a low cost construction and is divided into compartments that are connected in series. Each compartment includes a reactor pod containing cleaning media and/or bioremediation microbes. The temperature and pressure within the system is elevated, with water forced through the compartments on a regular cycle that lasts as little as 6-8 hours. The resulting effluent from the system is largely or completely free of per- and polyfluorinated substances and perfluorooctanoic acids (in comparison to the incoming waste water, with “largely free” being a 50, 75, or 90% greater reduction), as well as largely or completely free of medical waste and/or total suspended solids. The system can also deliver treated water at or target levels of carbonaceous biochemical oxygen demand.

### CROSS REFERENCE TO RELATED APPLICATIONS

This application claims priority to U.S. provisional patent application Ser. No. 63/467,626 filed on May 19, 2023, which is incorporated by reference.

### FIELD OF THE INVENTION

This application relates to various inventions for the treatment of waste water and, more particularly, to specialized, modular tanks and systems relying on those modular tanks to remove a wide range of contaminants from waste water through the action of bacterial digestion under temperature and pressure controlled conditions.

### BACKGROUND

Despite increasing need for improvements owing to population growth, salt water intrusion, extreme weather events, aquifier depletion, and the like, current sewage and waste water treatment methods have remained effectively unchanged for almost 70 years. These systems rely on large, open ponds. In addition to posing inherent worksite hazards, these arrangements require significant tracts of real estate that must be dedicated solely to that purpose. They also tend to require anywhere from 12 up to 48 hours per cycle, meaning that increased throughput necessarily requires an even larger number of settling ponds (and the sludge they inevitably produce).

Additionally, these existing solutions produce toxic residual sludge that must be transported and disposed of, thereby imposing additional costs. Further still, these processes are incapable remediating pollutants that have only recently gained prominence (or, in some cases, were only invented after the basic process was established). For example, per- and polyfluorinated substances and perfluorooctanoic acids (collectively referred to as “PFAS” or “forever chemicals” hereafter) have recently become a major concern, as has organic matter evolved from medical waste streams. PFAS generically refers to a large of thousands of fluorinated carbon-based molecules/polymers that are used in a wide range of consumer, industrial, and medical settings. PFAS is particularly useful to the extent many of its forms are resistant to degradation caused by heat, while also possessing water, oil, and/or fat resistance/“phobicity”.

Given the above, there remains a need for waste treatment systems, components, and methods that allow fast throughput. Modular and scalable solutions would also be welcome, as these could be right sized for municipal-level operations, as well as micro-scale installations (as might be found on ocean-going vessels, military installations, or remote areas in which sewers and/or plumbing may not be feasible). Finally and perhaps most importantly, systems, components, and methods that remove PFAS—especially given the likelihood of more stringent laws and regulations—are needed.

### SUMMARY OF INVENTION

A waste water treatment system is made from modular tanks connected in series. Each tank has a low cost construction and is divided into compartments that are connected in series. Each compartment includes a reactor pod containing cleaning media and/or bioremediation microbes. The temperature and pressure within the system is elevated, with water forced through the compartments on a regular cycle that lasts as little as 6-8 hours. The resulting effluent from the system is largely or completely free of per- and polyfluorinated substances and perfluorooctanoic acids (in comparison to the incoming waste water, with “largely free” being a 50, 75, or 90% greater reduction), as well as largely or completely free of medical waste and/or total suspended solids. The system can also deliver treated water at or target levels of carbonaceous biochemical oxygen demand.

### BRIEF DESCRIPTION OF THE DRAWINGS

The appended drawings form part of this specification, and any information on/in the drawings is both literally encompassed (i.e., the actual stated values) and relatively encompassed (e.g., ratios for respective dimensions of parts). In the same manner, the relative positioning and relationship of the components as shown in these drawings, as well as their function, shape, dimensions, and appearance, may all further inform certain aspects of the invention as if fully rewritten herein. Unless otherwise stated, all dimensions in the drawings are with reference to inches, and any printed information on/in the drawings form part of this written disclosure.

In the drawings and attachments, all of which are incorporated as part of this disclosure:

FIGS. 1A and 1B are a perspective views of a modular reaction tank according to certain aspects of the invention, with internal components shown in broken lines so as to highlight the contents of each of the divided compartment and pods enclosed within the tank. The first/left-most compartment in each of these drawings illustrates how access to the interior of each compartment can be gained by way of the access hatches running along the top of each tank.

FIGS. 2A and 2B are, respectively speaking, top plan views of the tanks of FIGS. 1A and 1B.

FIGS. 3A and 3B are, respectively speaking, cross sectional side views of the tanks of FIGS. 1A and 1B, taken along a central axis extending down the middle of the inlet and outlet pipes.

FIGS. 4A and 4B are, respectively speaking, transverse cross sectional views taken along line 4a-4a in FIG. 2A and line 4b-4b in FIG. 2B.

FIGS. 5A and 5B are, respectively speaking, perspective cross sectional cutaway views of the first (i.e., left most) compartments, along with portions of the second, as shown in FIGS. 1A and 1B.

FIG. 6 is an exploded cross-sectional view of call outs in FIGS. 5A and 5B, highlighting the double-layer, honeycomb-insulated outer walls of the tank, as well as the placement of gussets along all outer-facing seams. A portion of the inner vertical and horizontal walls are shown in partial cutaway to further illustrate the honeycomb insulation.

FIGS. 7A and 7B are a schematic representations of the configuration of waste water treatment systems contemplated by the various aspects disclosed herein.

### DESCRIPTION OF THE SELECTED EMBODIMENTS

Operation of the invention may be better understood by reference to the detailed description, drawings, claims, and abstract-all of which form part of this written disclosure. While specific aspects and embodiments are contemplated, it will be understood that persons of skill in this field will be able to adapt and/or substitute certain teachings without departing from the underlying invention. Consequently, this disclosure should not be read as unduly limiting the invention(s).

As used herein, the words “example” and “exemplary” mean an instance or illustration and, as such, are not intended to indicate a key or preferred aspect or embodiment. The word “or” should be construed as inclusive rather an exclusive, unless context suggests otherwise. For example, the phrase “A employs B or C,” includes any combination or permutation (e.g., A employs B; A employs C; or A employs both B and C). As another matter, the articles “a” and “an” are generally intended to mean “one or more” unless context suggest otherwise.

Understanding that the invention is particularly useful in waste water treatment systems, this disclosure should be read in context to the various terms of art common to that field. References to “upstream” and “downstream” are within the context of waste water entering at an initial inlet 111 and exiting at a final outlet 113, although certain aspects may be plumbed to divert or loop all or portions of flow within a circuit. Further, all measurements are taken at ambient temperature and pressure, with it being understood that differences in season and local climate may be significant considerations for certain aspects. Any molecular weights are with reference to weight averages, unless stated otherwise.

Because a treatment system is contemplated, it will be understood that comparative terminology should be read in context but will generally be used to demonstrate improvements in the effluent/treated water as opposed to the influent/waste water. While complete elimination of contaminants is always the goal, it will be understood that a 50% reduction in any given trait can be deemed significant, with more preferred levels of reduction of at least 75%, at least 90%, and at least 95% being inherent to various disclosed aspects herein.

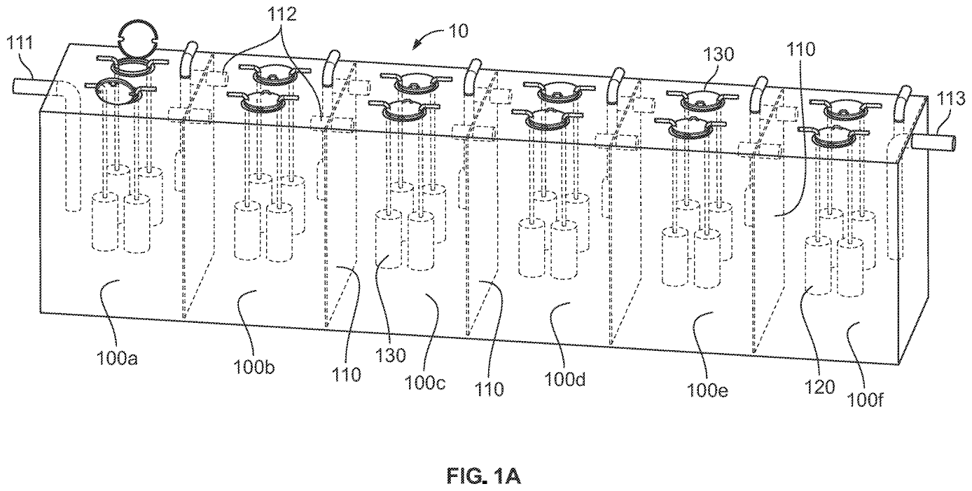

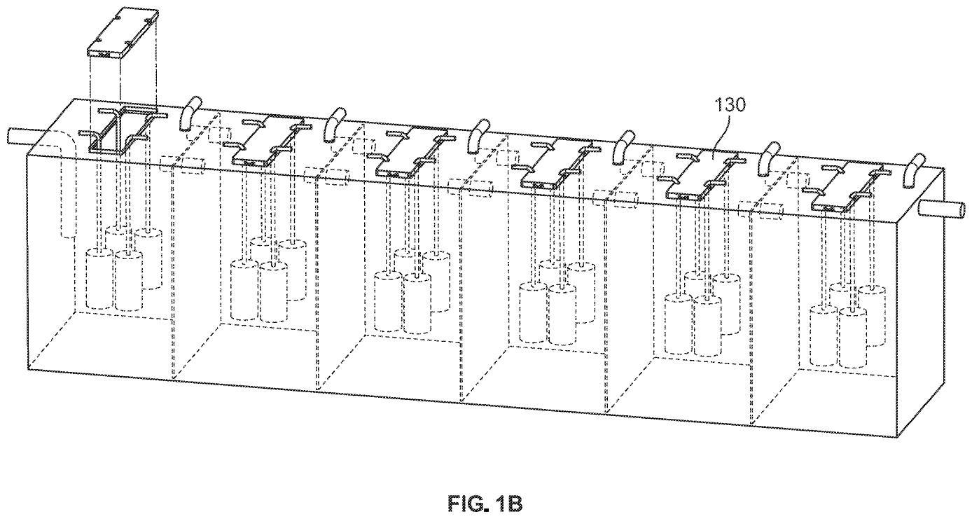

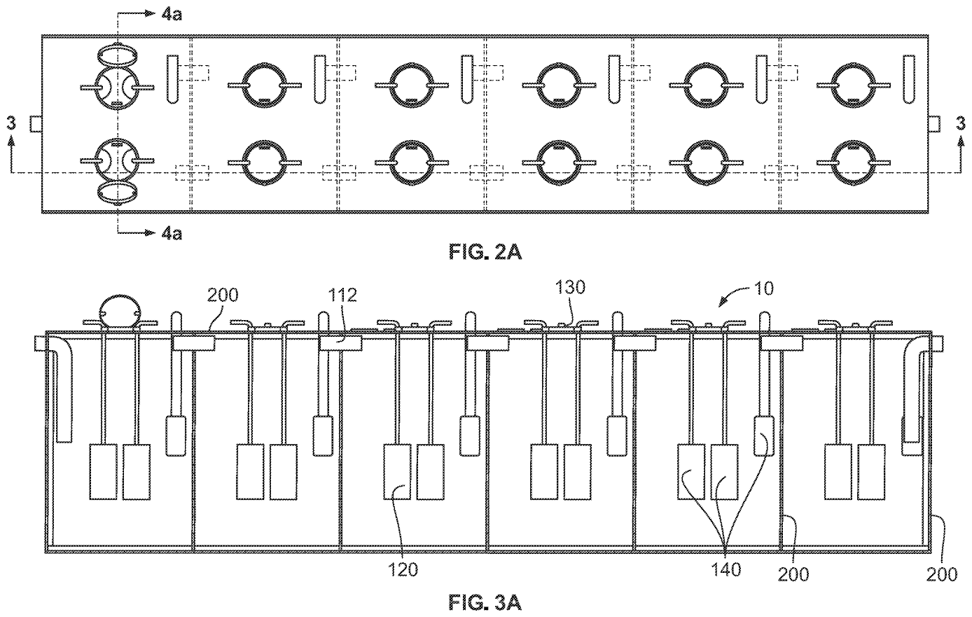

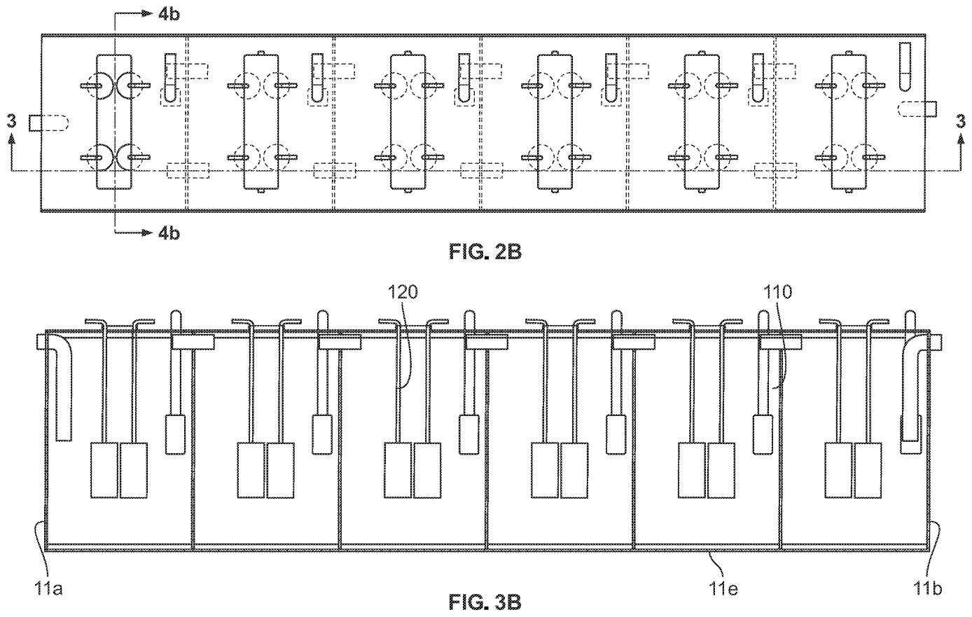

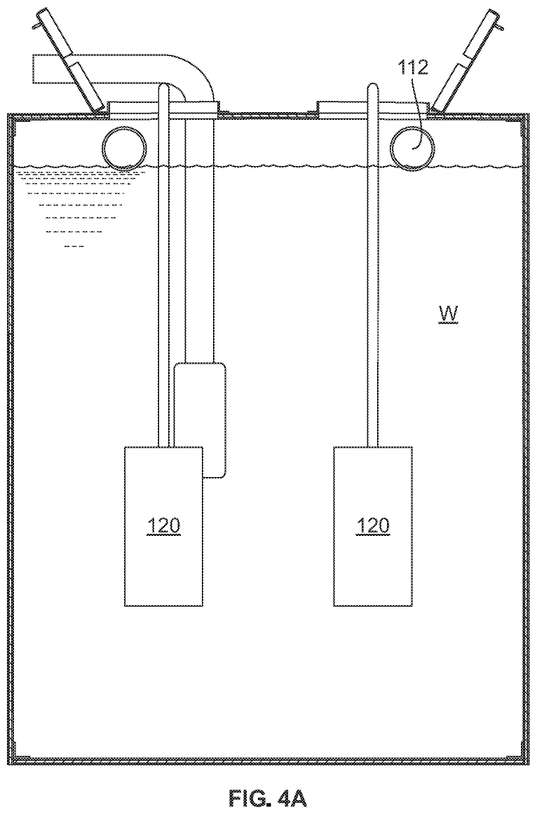

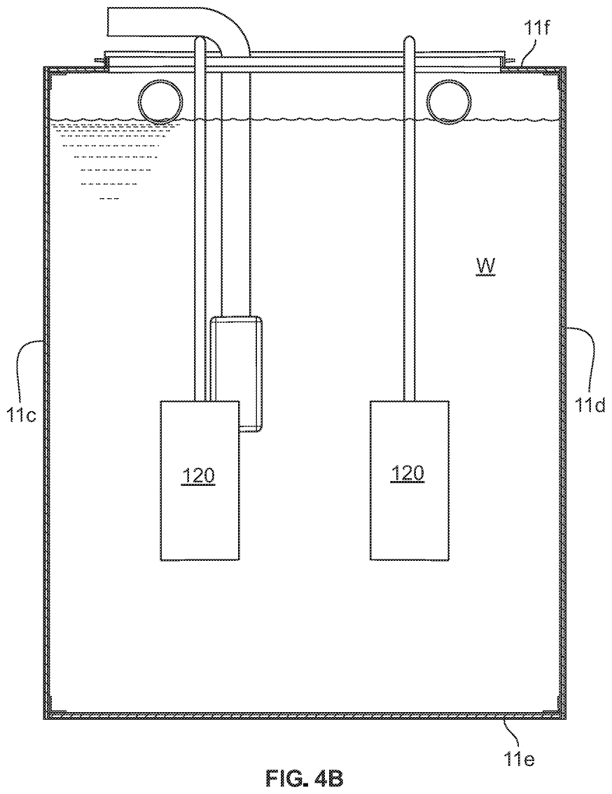

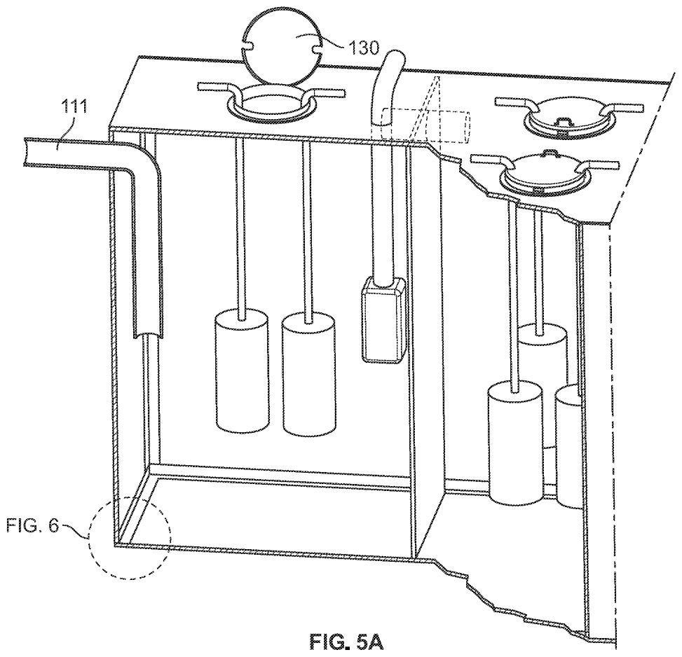

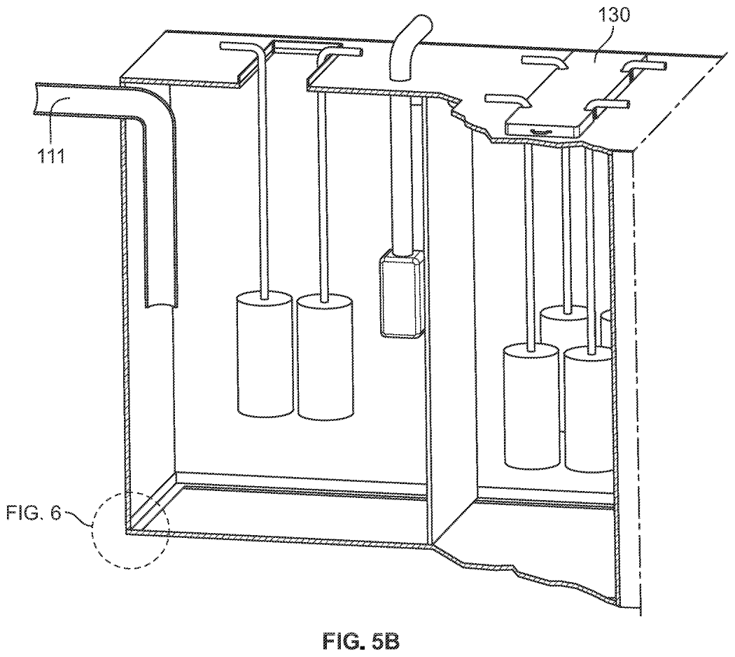

The inventors envision a water treatment system 1 based on a plurality of modular tanks 10 having a series of compartments 100, with multiple cleaning pods 120 suspended from an access portal or hatch 130 (either provided as a hinged cover as in FIG. 1A or as unitary removable panel as in FIG. 1B). The tanks 10 can be mass produced to defray manufacturing costs, while the precise contents of each compartment 100 and/or pod 120 can be customized and arranged/plumbed in a particular order to achieve waste water treatment that includes PFAS and medical waste removal in as little as six hours.

The system 1 relies on bacterial digestion of organic matter, similar to existing sewage treatments. However, the use of modular tanks 10 allows for pressurization and more rigorous temperature control, while the tanks themselves can be partially or completely underground so as to allow for potential secondary uses of at least portions of the real estate on which the treatment plant is located. Also, as used herein, “series” or provided “in series” means that the flow occurs in a linear fashion going from one to tank to the next downstream tank or one compartment to the next downstream compartment.

In particular, aspects of the system 1 may leverage various microorganisms to degrade pollutants dissolved or suspended in waste water effluents. These microorganisms might also include single-cell or multi-cell animals, protozoans, and/or metazoans, many of which are found in natural environments, as well as those that evolve or are engineered for the specific purpose of waste water treatment (in fact, existing treatment facilities may have cultures that evolved and became optimized over time in order to adjust to the climate and conditions of that particular location). These microorganisms consist of or comprise one or more strains of aerobic, anaerobic, and/or facultative (i.e., capable of adapting and surviving under aerobic or anaerobic conditions) bacteria in order to digest organic matter in the effluent.

A recent study by the National Institutes of Health, published in September 2023 (v.74 (3); 2023 Sep), summarizes a range of microbes that may be useful in bioremediation. For example, Escherichia coli and Proteobacteria are known to tolerate PFAS contamination in soil and aquatic environments. Other species, such as Acidimicrobium sp. and Pseudomonas parafulva, have the ability the facilitate the microbial degradation of PFAS. Generally speaking, it is believed such species attack PFAS through defluorination, decarboxylation, desulphonation, dechlorination, and/or carbon-carbon bond cleavage by way of various oxidation/reduction, hydrolysis, substitution, and elimination reaction pathways.

A wide variety of such microorganisms are commercially available, with REX-BAC-T Technologies of Cumming, Georgia; Norwalk Wastewater Equipment Company of Norwalk, Ohio; Probiotic Solutions of Gilbert, Arizona; Great Lakes Bio Systems, Inc. of Sturtevant, Wisconsin; and ClearBlu Environmental of Monterey, California all providing examples so suitable microorganisms. Still other suppliers and sources of appropriate microorganisms are known, and bacteria drawn from animal or other natural sources can be tested for efficacy and selected, combined, genetically engineered, or otherwise adapted to ensure an effective overall mix.

One of the reasons for the proliferation of suppliers is precisely because of the variable conditions of almost all wastewater treatment plants, see Table 1. That is, insofar as living animals are an integral part of these systems, they must identify and cultivate bacteria capable of surviving and thriving in an open pond that may experience changes in temperature and exposure to UV radiation, among other variables. Typical installations may experience average daily winter temperatures as low as 20° F. to 30° F. and average daily temperatures approaching 90° F. to 100° F., while such winter and summer temperatures for preferred locations might be between 40° F. to 80° F. Significantly, the disclosed system is specifically designed to accommodate these- and possibly even larger-variations.

In order to control, accommodate, and promote the growth of specific microbes, the inventors created a staged system, relying on a standardized tank structure. Waste water W is periodically and progressively pumped (and/or flows via gravity) into the system at a pressure of anywhere from 5 to 20 pounds per square inch (psi), with preferred ranges of 7 to 15 psi and 10 to 12 psi, and nominal targets of 9, 10, or 11 psi. Modular tanks are arranged in series so as to reduce and/or eliminate specific characteristics at each stage. For example, the first stages focus on the consumption and reduction of total suspended solids (TSS) and/or target levels of carbonaceous biochemical oxygen demand (CBOD). Subsequent stages target medical waste and PFAS.

Notably, the order and arrangement of these stages is significant. By way of example (and without wishing to be bound by any theory of operation), the inventor established that the near elimination of suspended solids enables the biological digestion of medical waste and/or PFAS in the subsequent stages. Further, whereas existing systems rely upon flocculation and/or settlement followed by physical removal of solids, the inventive process contemplates pre-treatment in which large and obvious obstructions (sticks, stones, bottles, other obvious rubbish, etc.) are removed by way of grates, sluices, or other similar means so as to provide an influent to the first tank that contains significant levels of TSS.

Another important aspect of the system resides in the tanks themselves, as depicted in the Figures. Each tank has a series of 6 compartments, preferably all having the same dimensions and equipment, although the precise number of compartments and resident times can be adjusted to maximize performance and possibly reduce complexity. Waste water is provided in corresponding volumes at set periods of time, such as every 10 to 30 minutes, with 15 and 20 minute cycles being preferred. Each pod includes a sensor to monitor temperature, pressure, water level, and other salient conditions. At least one or two ports are provided in the top of each pod, to allow for access to inspect and maintain the system. The ports also allow for one or two reactors to suspended so as to be centrally located within the volume of each pod. A heater unit may also be provided in each pod, although it is envisioned that the use of a compressor (feeding multiple tanks and treatment lines) without an after cooler will help maintain and regulate desired temperatures.

In one of its broadest aspects, heaters, compressors, or other similar implements will be positioned to insure that the fluids inside of the tank remains above the ambient exterior temperature (e.g., above the exterior air temperature in above ground installations or above the 50° F. to 70° F. typically encountered by underground piping/storage), although the temperature should be maintained below the ambient boiling point of water (normally 212° F. at sea level). More particularly, the absence of an after cooler on a conventional compressor will output compressed air at a temperature of 85° F. up to 200° F. so that the compressed air will serve to heat the fluids passing through the tank. More preferably, controls should be configured to insure air temperatures of 160° F. to 180° F., or most preferably between 170° F. and 180° F., thereby warming the treated water to a temperature that promotes and optimizes bacterial digestion (i.e., greater than the initial ambient temperature of the influent waste water and less than the temperature of compressed air and, more preferably, between 80° F. and 120° F. or between 85° F. to 95° F.). Notably, and as demonstrated by Table 1, warm influents tend to allow for faster removal of TSS. Each tank is appropriately wired so as to deliver real time information to a centralized controller, thereby enabling semi- or fully automated adjustments.

One or more layered plastic sheets 20 form all exterior tank walls 11, including upstream wall 11a, downstream wall 11b, lengthwise walls 11c, 11d, bottom wall 11e, and top wall 11f, and individual compartment dividers 110 made from one or a plurality of plastic sheets. For ease of manufacture, these sheets can be standardized (in terms of size, thickness, and/or weight) and made of extruded or molded polyethylene at a thickness appropriate to sustain the pressure and weight of water, components (e.g., heaters, compressors, plumbing, access equipment, etc.), and reactants (e.g., microbes/cultures, chemical treatments, etc.) expected to be encountered. In one aspect, each tank can be approximately 4 feet in height by 1 foot in length and 1 foot in depth, although it will be understood that other dimensions are feasible and encompassed by this disclosure.

Within the walls of the tank, an insulating matrix 30 potentially comprising an extruded polymeric cellular material may be encased between two sheets 20 that define the walls 11, although insulation may not be required or desired for the dividers 110 (so as to allow for more efficient heat transfer and equilibration). In some aspects, the matrix 30 may have a hexagonal or other repeating unit structure in order to simplify manufacture, as well as to capture air to insulate and prevent or minimize unwanted fluctuations in the temperatures experienced inside the tank 10. In some aspects, the thickness of the cellular material comprising the matrix 30 will be the same or larger than the thickness of the flat panel sheets walls 20 on either side of it. In other aspects, the matrix 30 could comprise foam or fibrous substrates in place of or in addition to the cellular material.

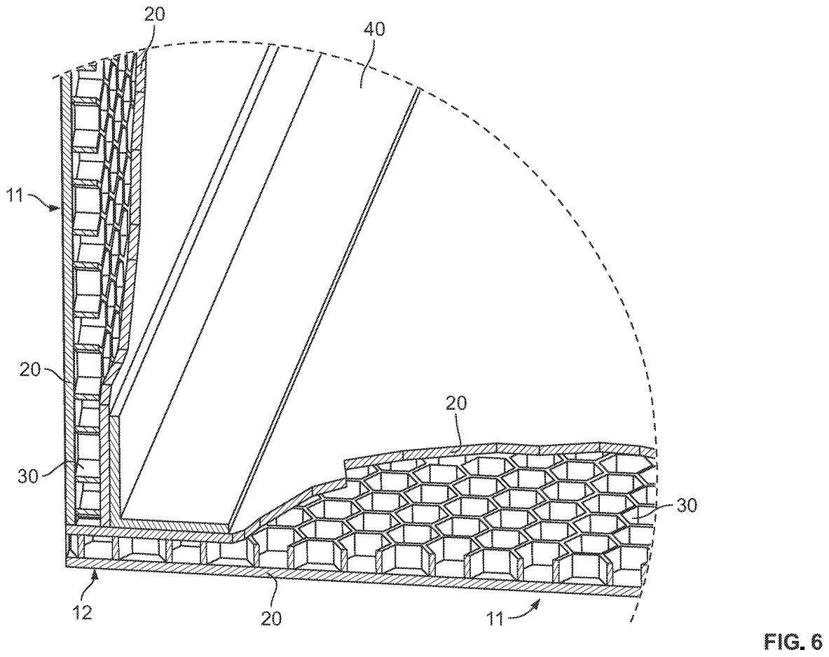

Along the outer junctions 12, a separate L-shaped gusset 40 is provided (as seen in FIG. 6). These gussets 40 provide increased surface area for hermetically sealing the tank, thereby serving as a safeguard against further unwanted leaks.

TABLE 1
Selected Operating Conditions of Existing
Wastewater Treatment Systems.

| | | Effluent | | | | Influent | |
|---|---|---|---|---|---|---|---|
| | | 7-day | 7-day | 30-day | 30-day | 30-day | 30-day |
| | | avg. | avg. | avg. | avg. | avg. | avg. |
| Month | Week | CBOD₅ | TSS | CBOD₅ | TSS | BOD₅ | TSS |
| 1 | 1 | 16 | 14.7 | 15 | 9.0 | 192 | 174 |
| | 2 | 12 | 5.5 | | | | |
| | 3 | 15 | 8.3 | | | | |
| | 4 | 16 | 6.6 | | | | |
| 2 | 5 | 22 | 5.4 | 16 | 5.6 | 208 | 183 |
| | 6 | 17 | 5.5 | | | | |
| | 7 | 13 | 6.2 | | | | |
| | 8 | 13 | 5.4 | | | | |
| 3 | 9 | 16 | 5.6 | 14 | 6.7 | 195 | 180 |
| | 10 | 12 | 5.3 | | | | |
| | 11 | 15 | 8.2 | | | | |
| | 12 | 14 | 8.1 | | | | |
| 4 | 13 | 13 | 7.0 | 12 | 7.7 | 172 | 150 |
| | 14 | 15 | 8.3 | | | | |
| | 15 | 11 | 10.0 | | | | |
| | 16 | 8 | 5.5 | | | | |
| 5 | 17 | 26 | 10.2 | 24 | 10.0 | 184 | 143 |
| | 18 | 36 | 11.8 | | | | |
| | 19 | 16 | 8.0 | | | | |
| | 20 | 16 | 7.8 | | | | |
| | 21 | 22 | 12.4 | | | | |
| 6 | 22 | *** | *** | 15 | 12.0 | 177 | 169 |
| | 23 | 16 | 6.6 | | | | |
| | 24 | 10 | 4.2 | | | | |
| | 25 | 15 | 11.5 | | | | |
| | 26 | 19 | 22.9 | | | | |
| | 27 | 12 | 12.3 | | | | |

The foregoing tank 10 can be constructed to withstand temperatures well above the targets described below. Further, while pressures should remain below 20 psi, the construction is capable of withstanding up to 60 psi.

As noted above, the tanks 10 are subdivided into discrete compartments 100. The compartments 100a through 100f are plumbed in series, with one or two headers 112 allowing for pressurized fluid to move from one compartment to the next. The reliance on pressure can minimize or eliminate the need to employ pumps at every junction.

The compartments 100 defined in each tank are divided by single sheet walls of similar construction to the individual panels/sheets 20 used in other parts of the system 1. Each compartment may contain a customized suite of cleaning equipment 140, such as the heaters, headers, flow pipes, sensors, pumps, filters, cleaning media, access ports, and/or suspended reactor pods. While each compartment 100 can be customized, the cleaning equipment itself is standardized and/or of identical construction, so as to enable mass production and streamlined maintenance.

Each compartment 100 includes a hatch or portal 130. As seen in FIG. 1A et seq., the hatch can be a hinged cover which can accommodate one or two suspended pods 120. In contrast, FIG. 1B et seq. provides for a single removable plate capable of accommodating up to four or more pods 120 within that compartment. In either instance, the portal 130 provides an access point for maintenance and replacement (when needed) of the pods 120 or replenishment or cleaning of the items contained therein.

In some aspects, some or all of the pods 120 will have a hollow interior that can be filled with discrete cleaning media, such as porous pumice or other common substrates having similar porosity and tortuosity. This provides a “nesting system” for bacteria (i.e., bioremediation microbes) and causes PFAS and other contaminants to be entrained within the porous surface where bacteria consumes the carbon source contained therein. Ports or other means of allowing flow into and out of the pod are provided, possible by way of valve connections, movable diaphragms, or other structures that selective admit and release fluid while retaining the cleaning media within the interior. Notably, bioremediation microbes can be provided in any pod and at any stage of the filtration system so as to insure efficacy and redundancy in cleaning capabilities, particularly with respect to PFAS, medical waste, and pathogens.

In some aspect, the pods 120 also contain ion-exchange polymers. These polymers may be provided as resins to form an insoluble matrix (or support structure) normally in the form of small (0.25-1.43 mm radius) microbeads or other organically formed substrates. Such substrates will be porous with significant tortuosity, thereby providing a large surface area on and within the substrate to trap or release of selected ions. Here again, multiple types of ion-exchange resin of different design and makeup that each affect, replace and release different ions within molecules as part of the purification process, and these are known in the field. By way of example rather than limitation, weak acid and strong acid cation resins can be alternated (on a pod-by-pod basis) with weak base and strong base anion resins. Chelate resins can also be used.

Notably, sequencing of particular types of ion exchange resins can be important. For example, weak acid cations remove iron and manganese and other problematic ions in the early stages of the process so as to avoid fouling of the surface of the strong acid cations, which would otherwise reduce the effectiveness of the ion exchange resins. Also, through the use of the compartmented tanks with individual pods, it is possible to achieve such sequencing on a targeted scale.

Modular “ultrafiltration” systems can also be employed within or after part of the treatment system. These systems are sold as discrete units in which the filtration media is contained with a standard sized tube, so as to simplify connections and use. Generally speaking, these systems may include a series of capillaries having a diameter between 500 to 2,000 micrometers that deliver/disperse fluid for treatment through one or more membranes having pores at the micron or nanometer scale (e.g., 10-1,000 nanometers). Such ultrafiltration systems may be incorporated within the series of tanks and/or as part of a final filtration system associated with the effluent from the final modular tank (but prior to returning treated water for public use). The use and positioning of ultrafiltration systems can be useful in preserving and extending the life of other cleaning media that may be more sensitive to selected solids or other contaminants.

Appropriate materials for these purposes (i.e., any of the aforementioned cleaning media and/or external filtration units) can be purchased from DuPont Water Solutions in Edina, Minnesota; Mitsubishi Chemical Corporation in Charlotte, North Carolina; Evoqua Water Technologies in Pittsburgh, Pennsylvania; Fort Bend Services, Inc. in Stafford, Texas; Purolite in King of Prussia, Pennsylvania; and the Dow Chemical Company in Midland, Michigan. As above, pods containing these exchange resins can be fitted with appropriate valve placement, diaphragms, etc.

The pods 120 may also serve as an initial means to introduce desired bacteria/microbes into specific compartments or tanks. In such cases, appropriates cultures/conditions are created in or on the pod, with the expectation that the desired microbes can and will be sustained in order to promote PFAS, medical waste, or other targeted chemical/bioremediation. Any of the aforementioned microbes/bacteria are prospective candidates. Provided they are compatible, multiple different microbes can be included in a single pod or within a given compartment or tank.

In addition to interior storage space for cleaning media, ion-exchange resins, and/or carbon filtration media, the pods 120 may also be outfitted with an array of sensors and control equipment. For example, one or more thermocouples or thermometers, pressure sensors, and water level detectors can be disposed in or on one or more of the outer facings of the pods 120. It may be possible to outfit only one pod per compartment to save on costs. But these sensors will allow for continuous data capture and prospective automation of the system, as well as to monitor for potential failures or other issues.

Any of the foregoing resins can be further combined or used in conjunction with granular or other activated carbon within one or all of the pods 120. Such activated carbon can also be provided in its own right. These carbons can be useful in addressing PFAS, although the system is specifically designed for the bacterial digestion and destruction of PFAS, so as to minimize the need to dispose of PFAS-contaminated carbon or filtration media (as is the current practice). In addition to the previously identified sources of ion-exchange resins—many of whom also offer acceptable activated carbons—the Calgon Carbon Corporation of Moon Township, Pennsylvania sells various forms of acceptable activated carbons.

The pods 120 are suspended from the portal 130 by rods or cables. The length of the rods or cables can be adjusted to insure portions or the entirety of the pod 120 is in proper communication with the fluids in the system.

In one arrangement of the system 1, four successive tanks 10 are connected in series. Tank A holds sewage for one and a half hours removing solids to below 10 ppm. The control of the temperature allows for consistent and monitored total suspended solids exceeding performance without fluctuation. Tank B holds sewage for one and a half hours and removes solids significantly below standard systems not utilizing this innovation. Because tanks A and B operate at controlled and elevated constant temperature (i.e., fluctuations of less than 10° F. throughout any given operating cycle and, more ideally, throughout an entire week, month, or lifetime of operation), all suspended solids are removed through bacterial digestion and the system does not produce a sludge by-product.

Tank C holds sewage for one and a half hours to remove medical waste—the absence of other suspended solids that would normally be the target of bacterial activity and the addition of this processing tank results in the consumption of medical waste through adaptive behaviors of the reactor bacteria. Reactors and/or pods in Tank D will contain a combination of activated carbon, zeolite, ion exchange resins, and cleaning media, with refinements based upon localized conditions, bacteria activity, and the like. As such, this “end stage” tank D acts as a catch point for PFAS. To that end, the pods may include and alternate between positive ions and negative ions in each pod (i.e., three pods containing a positive ion exchange resin and 3 pods containing a negative ion exchange resin).

The process of removing total suspended solids to a level significantly below other systems starves the bacteria in the later part of the system (i.e., tanks C and D) of any readily available food sources. The adaptive nature of the bacteria will lead to the bacterial consumption of PFAS and other contaminants due to their being starved of other suitable food sources. Following the consumption of carbon in PFAS the free fluoride combines with minerals in the pumice to create fluoride.

Each tank is connected in series so that effluent from tank A becomes the influent for Tank B, and so on. The life expectancy of the system is improved by this “series” design because filtration in the early stages insures comparatively cleaner water being provided to Ion Exchange Resins in the late stages. This prolongs the utility of the ion-exhange media and should significantly enhanced life expectancy of the system so as to allow 10-15 years of use. As a further enhancement, carbon filters can be employed at the very end of the process (for effluent from tank D and/or, in some instances, for the effluent from tank C before it is provided to tank D so as to order to further maximize the lifespan of the ion exchange resins). As before, these arrangements significantly enhance the life expectancy of the carbon filters, thereby reducing the costs of maintenance, cleaning and replacement.

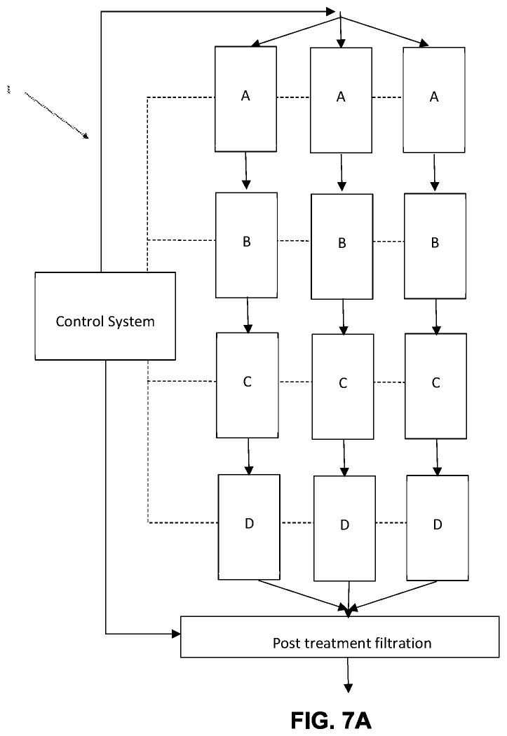

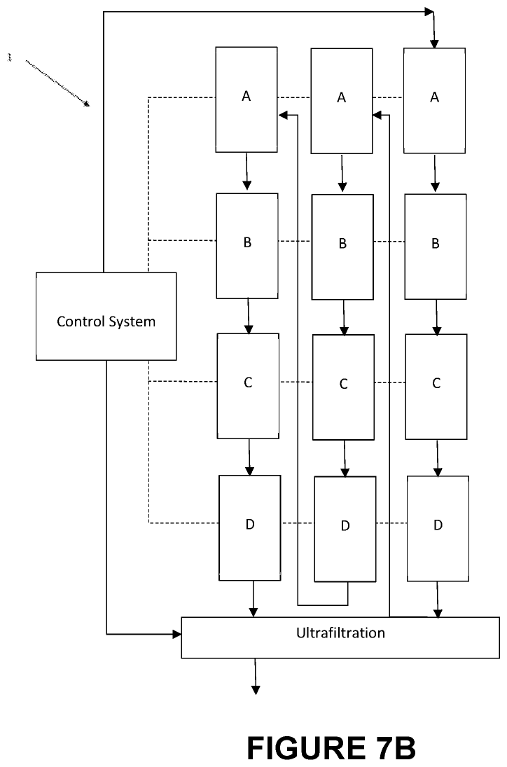

With reference to the schematic representations of FIGS. 7A and 7B, a single unit can control multiple, repetitive elements within the system via appropriate plumbing and valve placement. For example, a single compressor or control system can be employed for one complete line (i.e., tanks A through D). Similarly, a single carbon filtration system could be centralized so as to receive and filter effluent from multiple, different end stage tanks (i.e., effluent from tank D). In such arrangements, and particularly that shown in FIG. 7B, it is possible to prolong the useful life of cleaning media in downstream tanks, while also providing a separate mechanism and access point by which a single filtration system can be purged (i.e., backwashed), including during the non-cycling portions where influent is not being forced downstream, without disrupting the remaining elements or operation of the system.

Also, as noted above and as evidenced by the use of sensors, heaters, and automated controls within each tank and possibly even each pod, the system is designed to control heat, with such control being exerted on a pod-by-pod, tank-by-tank, or line-by-line basis so as to maintain the desired conditions and/or to alter overall system operation as may be dictated by the circumstances/observed conditions. The plastic honeycombed panels in the exterior walls of each tank 10 create an insulated thermal barrier, promoting efficiency of heat transfer and minimizing heat loss.

With wishing to be bound by a theory of operation, it is believed that the higher water temperature allows the ion exchange resins to react differently with PFAS. Similarly, positioning a zeolite in the final PFAS capture stage should also remove heavy metals. The lowered dissolved oxygen content of the water due to heating through the heating element and heated airflow results in better, optimized, conditions for the reactions with PFAS.

The system utilizes a Venturi closed loop system to draw oxygen into the effluent flow to ensure outgoing water is optimized for the next use case. This can be adjusted to optimal levels for wildlife in the event discharge is into a natural body of water, optimized for drinking water, or optimized for other purposes. More generally, reference to a “closed system” should be understood to mean that the treated waste water is not exposed to ambient air as may otherwise happen in systems that are reliant upon ponds, open pools, or open containers.

An aeration system 150 (nominally operating around 10 PSI per reactor, although other pressures are contemplated as noted above), in combination with the porous surface of the cleaning media, counteracts the hydrophobia of PFAS. Stirring heads can be added on the pods (for simplicity of wiring) or within the tank walls or floor so that, in the heated environment, inter- and intra-molecular bonding in, as well as other adhesion between, the PFAS and/or other contaminants become weakened and create opportunities for the bacteria to infiltrate and break down these components. The different pore sizes inside of the cleaning media traps PFAS and contaminants in place and allows bacteria time to conduct the process of breaking down and consuming the carbon.

Appropriate and preferably automated control systems are provided, in order to change operating pressure of each pod, temperature of each pod, volume of fluids entering and flowing through any given tank (via appropriate flowrate valves), and the like. This system will monitor and optimize the ongoing bacterial reactions inside the system, so as to enable accelerated operational cycle that gravity flow alone would not otherwise sustain. Notably, a number of factors, such as the insulation of the tank, the mixing of the water and air, and any heat losses due to evaporation or convection, must be taken into account in order to maintain the preferred operational temperatures and conditions within the system.

Pressure and gravity cooperate to induce flow one tank to the next. The design of each inlet and outlet pipes can further facilitate this action. The pump can be located at the head of the system in order to regulate flow and push new wastewater into the system while moving treated or partially treated water already in the system forward to the next tank. The airflow helps to move the water through the system through the churning process that is created. In one aspect, the series of tanks within the system are aligned along a grade that facilitates gravity feeding, thereby improving flow. Additionally or alternatively, site selection can insure that the inflow points are at a higher elevation than the final tanks/outlet.

In the same manner, the system 1 may be partially or completely buried. In such installations, the ground can serve as a means of moderating temperature changes, reducing heating costs, and/or guarding against unwanted cyclic heating from the ambient environment.

In further aspect, the system can comprise a stack of tanks 10. In some arrangements, a plurality of the same type of tank (e.g., Tank A, as described above) can be provided in a common plane, usually at the top of the stack. Plumbing will allow gravity fed flow into the layer immediately beneath it and so on. This arrangement also allows for redundant plumbing and valving so that out flows from any given tank could be redirected to other, lower tanks in the event one particular tank may need to be temporarily removed from service. Alternatively, the parts or all of the complete series can be provided in the same layer/level. In all instances, stacking the tanks in this manner allows for more efficient use of space and may also be more thermally efficient. However, care should be taken to insure the tank construction can withstand the loads, and access to the portals 130 should be maintained.

Given the elevated operating temperatures, use of enclosed tanks prevents unwanted evaporative loss that might otherwise exacerbate the concentration of solids in the waste water especially in comparison to existing treatment systems using ponds, pools, or open containment structures. Further, enclosed tanks can be partially or completely buried in order to provide additional insulation and temperature stability. And because the tanks are sealed by multiple layers, the risk of leakage is reduced while simultaneously insuring the integrity of the bacterial biota remains stable and is not subjected to intrusion by ambient wildlife or deleterious environmental conditions.

Complete reliance on polymeric materials reduces costs (in comparison to steel) and alleviates corrosion. Further, polyethylene and other, similar workable plastics are amenable to heat welding and/or chemical adhesion, in addition to the potential use of fasteners or customized fittings between the members. The resultant components and tanks can produced on a mass scale relying upon extant molding and extruding equipment, allowing for fast scaling and ramp up. Thus, an aspect of the invention includes a system in which no metallic or steel parts are required for the tanks, for the plumbing, and/or for any component within the system so as to reduce costs. This reduction or elimination of metallic components should also help to minimize weight of the system.

In view of the anticipated pressures and temperatures, the tanks 10 can be formed as cuboid shapes, with the sheets 20 joined by adhesives or fasteners at right angles. This avoids the need to mold or engineer curved sections, and therefore simplifies manufacture. Equally important, the cuboid shapes can be arranged more efficiently than rounded cylinders or tubes. Further still, the flattened sides of the tanks will allow for easier access points, as well as conforming the tanks to a selected grade (if needed). Transportation and installation will also be simplified.

In one aspect, the invention consists of a modular tank, constructed entirely from low-cost polymeric materials, such as polyethylene. The exterior walls of the tank have honeycomb insulated cellular structure encased by pair of polymer sheets joined. Additionally, a plurality of divided compartments are provided in the tank, with each compartment connected by flow-through headers and having at least one or all of the following: i) an individual control module, ii) ambient conditions sensors and/or a heater, iii) an access port for with at least one reactor pod suspended therefrom, and iv) digesting bacteria disposed in the reactor pod and/or cleaning media selected from a porous substrate (such as pumice), ion-exchange resins, and/or filtration media (such as activated carbon). Internal gussets seal some or all of the joints at the exterior walls and/or at the compartment dividers.

In a further aspect, a method of removing PFAS, medical waste, and/or unwanted debris from waste water is contemplated. Here, a plurality of identical modular tanks, like the ones described in previous aspects, are provided and plumbed so that waste water runs in series through anywhere from two to ten tanks, with a preferred system having four discrete tanks. Waste water is temperature and pressure controlled, and cycled through each compartment of each tank in time intervals of less than 30 minutes. Cleaning media and/or bioremediation microbes are provided to specific reactor pods in specific tanks so as to progressively remove large solids prior to digestion of smaller solids, medical waste, and PFAS. The total resident time for treatment of waste water according to this method is less than 12 hours and, more preferably, 6-8 hours.

In a final aspect, the invention includes a system for cleaning waste water. This system comprises a plurality of modular tanks constructed from a series of flat polymeric sheets and connected in series within a closed loop where pressure and temperature are each elevated and controlled by a control system. Each modular tank in this system has: i) six exterior walls with insulating material positioned between two spaced apart flat polymeric sheets, ii) an inlet disposed in an upstream exterior wall of each tank and an outlet disposed in an opposing downstream exterior wall, iii) a series of successive internal compartments arranged between the inlet and the outlet, each compartment defined by a flat polymeric divider sheet connected to opposing lengthwise exterior walls and a bottom wall with a connecting pipe passing through each flat polymeric divider sheet, and iv) a top wall having a series of portals associated with and providing access to each compartment. A plurality of reactor pods are each suspended from a selected portal into the compartment associated with the selected portal and wherein each reactor pod contains cleaning media that is at least one selected from a porous substrate, an ion exchange resin, at least one type of bioremediation microbes. A control system is also provided and operates so that treated water in the closed loop remains between 80 to 120 F and 5 to 20 pounds per square inch, with less than twelve hours of resident time in the closed loop. Additional aspects include one or any combination of the following:
bioremediation microbe is selected to digest per- and polyfluorinated substances and perfluorooctanoic acids so as to remove at least 50%, 75%, 90%, or 95% thereof when waste water provided into the system is compared against treated water exiting the system.
the system comprises four tanks with the cleaning media in the reactor pods of a first tank include a porous substrate, the cleaning media in the reactor pods of all remaining tanks including bioremediation microbes
control system includes a compressor (no after cooler)
control system operates in a cyclic fashion, so that waste water provided into the system is forced to move from one compartment to a successive compartment every 10 to 30 minutes
reactor pod has sensors providing information to the control system
selected compartments provided with heaters connected to and controlled by the control system
polymeric sheets consist of polyethylene
insulating material is a cellular honeycomb constructed from polyethylene
one portal per compartment with a single removable hatch covering each portal
a sluice or a grate is provided upstream of the inlet for a first tank in the series of modular tanks
a carbon filtration system is provided downstream of the outlet for a final tank in the series of modular tanks

All components of the system should be made of materials having sufficient flexibility, workability, and structural integrity, as well as being resistant to corrosion and the range of temperatures expected to be encountered while operation the system. Certain grades of polyethylene are particularly advantageous, with the understanding that high density (i.e., having a density of greater than 0.940 g/cm³) and lower density (e.g., medium density at 0.925 to 0.940 g/cm³ and/or lower density at 0.880 to 0.925 g/cm³) grades each possess inherent advantages. More generally, the invention may be implemented relying on other polyolefins, with particular utility in polypropylene as well as polyethylene. Further, copolymerization and the use of additives and adjuncts may be useful in improving the strength; the UV-, corrosion, or heat resistance; and/or other salient characteristics.

References to coupling in this disclosure are to be understood as encompassing any of the conventional means used in this field. This may take the form of snap- or force fitting connections, threaded connections, chemical and/or heat-activated adhesive(s) compounds, and metallic or polymeric fasteners. Components must be selected judiciously in view of structural, corrosion resistance, and other salient aspects noted above.

In the same manner, engagement may involve coupling or an abutting relationship. These terms, as well as any implicit or explicit reference to coupling, will should be considered in the context in which it is used, and any perceived ambiguity can potentially be resolved by referring to the drawings.

Although the present embodiments have been illustrated in the accompanying drawings and described in the foregoing detailed description, it is to be understood that the invention is not to be limited to just the embodiments disclosed, and numerous rearrangements, modifications and substitutions are also contemplated. The exemplary embodiment has been described with reference to the preferred embodiments, but further modifications and alterations encompass the preceding detailed description. These modifications and alterations also fall within the scope of the appended claims or the equivalents thereof.

We claim:

1. A system for cleaning waste water comprising:
a plurality of modular tanks constructed from flat polymeric sheets and connected in series within a closed loop where pressure and temperature are each elevated and controlled by a control system;
wherein each modular tank has: i) six exterior walls with insulating material positioned between two spaced apart flat polymeric sheets, ii) an inlet disposed in an upstream exterior wall of each tank and an outlet disposed in an opposing downstream exterior wall, iii) a series of successive internal compartments arranged between the inlet and the outlet, each compartment defined by a flat polymeric divider sheet connected to opposing lengthwise exterior walls and a bottom wall with a connecting pipe passing through each flat polymeric divider sheet, and iv) a top wall having a series of portals associated with and providing access to each compartment;
wherein a plurality of reactor pods are each suspended from a selected portal into the compartment associated with the selected portal and wherein each reactor pod contains cleaning media;
wherein the cleaning media is at least one selected from a porous substrate, an ion exchange resin, at least one type of bioremediation microbes
wherein the control system operates so that treated water in the closed loop remains between 80 to 120 F and 5 to 20 pounds per square inch, with less than twelve hours of resident time in the closed loop.

2. The system of claim 1 wherein bioremediation microbe is selected to digest per- and polyfluorinated substances and perfluorooctanoic acids so as to remove at least 50% thereof when waste water initially provided into the system is compared against treated water exiting the system.

3. The system of claim 2 wherein the system comprises four tanks with the cleaning media in the reactor pods of a first tank include a porous substrate, the cleaning media in the reactor pods of all remaining tanks including bioremediation microbes.

4. The system of claim 1 wherein control system includes a compressor configured to heat the treated water.

5. The system of claim 1 wherein the control system operates in a cyclic fashion, so that waste water provided into the system is forced to move from one compartment to a successive compartment every 10 to 30 minutes.

6. The system of claim 1 wherein at least one reactor pod has sensors providing information to the control system.

7. The system of claim 1 wherein selected compartments provided with heaters connected to and controlled by the control system.

8. The system of claim 3 wherein the polymeric sheets consist of polyethylene.

9. The system of claim 8 wherein the insulating material is a cellular honeycomb constructed from polyethylene.

10. The system of claim 1 wherein there is one portal per compartment in each tank and wherein a single removable hatch covering each portal.

11. The system of claim 1 further comprising a sluice or a grate is provided upstream of the inlet for a first tank in the series of modular tanks.

12. The system of claim 1 further comprising an ultrafiltration system is provided downstream of the outlet for a final tank in the series of modular tanks.

13. The system of claim 1 further comprising an ultrafiltration system is configured in-line to receive and filter partially treated water from the outlet of a selected modular tank and thereafter returning filtered water to the inlet of a subsequent modular tank.

14. The system of claim 13 wherein the ultrafiltration system is also configured to separately and subsequently receive and filter treated water from the outlet of a final modular tank in the system and thereafter produce treated effluent.
